(19) United States
(12) Patent Application Publication
(10) Pub. No.: US 2007/0074814 A1
(43) Pub. Date: Apr. 5, 2007

(54) Apparatus and method for treating a substrate with plasma, and facility for manufacturing semiconductor devices

(76) Inventors: Seok-Hyun Hahn, Suwon-si (KR); Young-Kyou Park, Seoul (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/513,154

(22) Filed: Aug. 31, 2006

(30) Foreign Application Priority Data
Oct. 4, 2005 (KR) 2005-93016

(51) Int. Cl. C23F 1/00; C03C 15/00

(52) U.S. Cl. 156/345.31; 156/345.38; 216/67

(57) ABSTRACT

A plurality of different types of plasma sources are used to treat a substrate. The plasma sources may be associated with a single process chamber. In this case, the plasma sources are selectively operated for treating the substrate in the process chamber. Alternatively, the plasma sources may be respectively associated with respective process chambers in an integrated manufacturing facility. According to the present invention, the operating parameters, e.g., sequence of use, of the plasma sources constitute additional process parameters that can be adjusted maximizing the efficiency of the process.

### BACKGROUND OF THE INVENTION

1. Field of the Invention

The present invention relates to a method and apparatus for treating substrates. More particularly, the present invention relates to a method and apparatus for treating the substrates with plasma.

2. Description of the Related Art

Various kinds of processes are used to manufacture semiconductor devices using substrates such as wafers. Many of the processes, such as deposition, etch, and cleaning processes, entail generating plasma from process gases and supplying the plasma to the substrates. Thus, an apparatus for carrying out a plasma treatment process includes a process chamber and a plasma generator that generates plasma and supplies the plasma to substrates in the process chamber. The plasma generator of an etching apparatus may be a Capacitively Coupled Plasma (CCP) generator, an Inductively Coupled Plasma (ICP) generator, a Reactive Ion Etching Plasma (RIE) generator, a Magnetically Enhanced Reactive Ion Etch (MERIE) plasma generator, an Electron Cyclotron Resonance (ECR) plasma generator, a direct plasma generator or a remote plasma generator.

FIGS. 1A to 1G illustrate examples of plasma treatment apparatuses having Capacitively Coupled Plasma (CCP), Inductively Coupled Plasma (ICP), Reactive Ion Etching Plasma (RIE), Magnetically Enhanced Reactive Ion Etch Plasma (MERIE), direct plasma, remote plasma, and Electron Cyclotron Resonance (ECR) plasma generators, respectively. In FIGS. 1A to 1G, reference numbers 10, 12, 14, and 16 denote a process chamber, an upper electrode, a lower electrode, and a high frequency power source, respectively. Referring FIG. 1A, the Capacitively Coupled Plasma (CCP) generator applies a high frequency alternating current (AC) to the upper electrode 12 and the lower electrode 14. Referring to FIG. 1B, the Inductively Coupled Plasma (ICP) generator applies a high frequency alternating current (AC) to a coil 18 surrounding the process chamber 10. Referring to FIG. 1C, the Reactive Ion Etching Plasma (RIE) plasma generator applies a high frequency alternating current (AC) to the lower electrode 14 while the upper electrode 12 is grounded. Referring FIG. 1D, the Magnetically Enhanced Reactive Ion Etch (MERIE) plasma generator includes the same structure as the Inductively Coupled Plasma (ICP) generator and further includes magnets 20 outside the process chamber 10. Referring to FIG. 1E, the direct plasma generator applies a high frequency alternating current (AC) to the upper electrode 12 while the lower electrode 14 is grounded. Referring FIG. 1G, the remote plasma generator generates the plasma outside of the process chamber 10 and the plasma is then supplied into the process chamber 10. The Electron Cyclotron Resonance (ECR) plasma generator comprises a microwave generator 24a and an electromagnet 24b. The detailed structures and operations of the plasma generators are well known in the art, per se. Therefore, a further detailed description thereof will be omitted.

Factors affecting the efficiency of the etch process include pressure and temperature at which the process is carried out, the amount and type of the process gas, the duration and magnitude of the applied high frequency electromagnetic field, etc. These factors are adjusted during the etch process, for example, in an attempt to maximize the efficiency of the process. A plasma treatment apparatus, in general, has only one of the plasma generators described above. Therefore, the efficiency of the etch process can be increased only so much by controlling only these factors. In addition, a plasma treatment apparatus has a limited number of applications, That is, the plasma generator adopted by the apparatus limits the number of different types of processes that the apparatus can carry out.

### SUMMARY OF THE INVENTION

An object of the present invention is to provide a plasma treatment apparatus or facility that can process a substrate efficiently.

Similarly, an object of the present invention is to provide an efficient method of treating a substrate with plasma.

Another object of the present invention is to provide a plasma treatment apparatus or facility which can perform a variety of plasma treatment processes on a substrate.

According to one aspect of the present invention, a plasma treatment apparatus includes a process chamber, and a plasma generation system including at least two different types of plasma generators. A substrate support is disposed in the process chamber for supporting a substrate while it is being processed. The apparatus also includes a gas supply system for supplying the process gas from which plasma is formed. The plasma generation system may also include a controller. The controller controls the plasma generators to selectively operate one at a time during a process of treating a substrate with plasma. For instance, the controller can control the plasma generators such that plasma sources can be switched for use in the middle of the process.

Preferably, each of the plasma generators is a Capacitively Coupled Plasma (CCP) generator, an Inductively Coupled Plasma (ICP) generator, a Reactive Ion Etching (RIE) plasma generator, a Magnetically Enhanced Reactive Ion Etch (MERIE) plasma generator, an Electron Cyclotron Resonance (ECR) plasma generator, a direct plasma generator, or a remote plasma generator.

According to another aspect of the present invention, a facility for manufacturing semiconductor devices or the like includes a transfer chamber, a transfer robot disposed in the transfer chamber, and a plurality of plasma treatment apparatuses connected the transfer chamber wherein at least one of the plasma treatment apparatuses includes a plasma generator of a type that is different from that of the plasma generator of at least one of the other plasma treatment apparatuses. The facility for manufacturing semiconductor devices or the like may further include an ashing apparatus and a wet strip apparatus connected to the transfer chamber.

According to still another aspect of the present invention, a method of processing a substrate includes initially treating the substrate with plasma produced using a first plasma generator to form part of a feature on the substrate, and subsequently treating the substrate with plasma formed using a second plasma generator of a type different from that of the first plasma generator to form a continuation of the feature on the substrate.

In the case in which the method is applied to an etching process, material on the substrate is etched by the plasma, formed using the second plasma generator, preferably at a rate lower than that in which material on the substrate is etched by the plasma formed using the first plasma generator. To this end, a Capacitively Coupled Plasma (CCP) may be formed using the second plasma generator, and an Inductively Coupled Plasma (ICP) may be formed using the first plasma generator. In addition, when the material to be etched includes a plurality of different layers, the different types of plasma generators can be used to produce the plasma for etching the layers, respectively.

According to still another aspect of the present invention, a single layer of material on a substrate is etched through only part of its thickness by with a plasma formed using a first plasma generator, and subsequently the etching of the single layer of material on the substrate is continued with a plasma formed using a second plasma generator of a type that is different from that of the first plasma generator.

In this respect, the single layer of material on the substrate can be etched in a single process chamber by both the plasma formed using the first plasma generator and the plasma formed using the second plasma generator. Alternatively, the single layer of material on the substrate can be etched in different process chambers.

### BRIEF DESCRIPTION OF THE DRAWINGS

The above and other objects, features and advantages of the present invention will become more readily apparent from the following detailed description thereof made with reference to the accompanying drawings wherein:

FIGS. 1A to 1G are schematic diagrams of various conventional plasma treatment apparatuses;

FIG. 2 is a block diagram of an embodiment of a plasma treatment apparatus according to present invention;

FIG. 3 is a sectional view of an embodiment of the plasma treatment apparatus of FIG. 2;

FIG. 4 to FIG. 6 are schematic diagrams of different embodiments of the plasma treatment apparatus of FIG. 2;

FIG. 7 is an explanatory diagram of a section of a substrate illustrating the plasma etching of an oxide layer using a plasma treatment apparatus according to the present invention;

FIG. 8 is an explanatory diagram of a section of a substrate illustrating the etching an oxide layer and a poly layer using a plasma treatment apparatus according to the present invention; and

FIG. 9 is a schematic plan view of a facility for manufacturing semiconductor devices including plasma treatment apparatuses according to the present invention.

### DETAILED DESCRIPTION OF THE PREFERRED EMBODIMENTS

The present invention will be described below in more detail with reference to the accompanying drawings. An etch apparatus will be used for describing the embodiments of the present invention. However, it should be noted that the present invention can be equally applied to other process apparatuses using plasma, such as a cleaning apparatus or a deposition apparatus. In addition, a wafer W will be used as an example of an object that can be processed by an apparatus according to the present invention, but obviously the present invention can be used to process other types of substrates such as glass substrates.

FIG. 2 illustrates an embodiment of a plasma treatment apparatus of present invention. Referring to FIG. 2, the plasma treatment apparatus includes a process chamber 100 and a plasma generation system 200. The process chamber 100 provides a space in which a process is carried out. The plasma generation system 200 includes a plurality of (two or more) plasma generators 220 and a controller 240 for controlling the plasma generators 220.

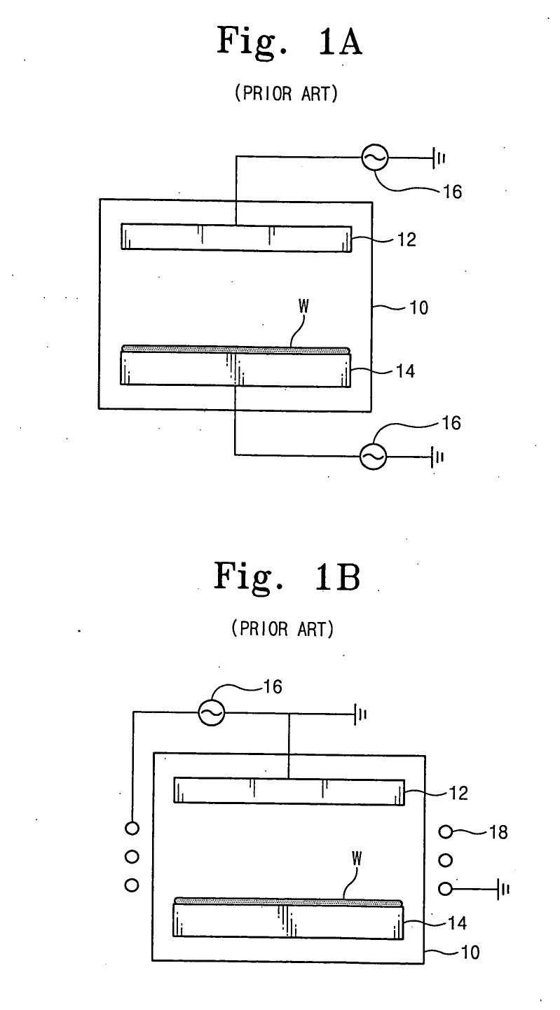

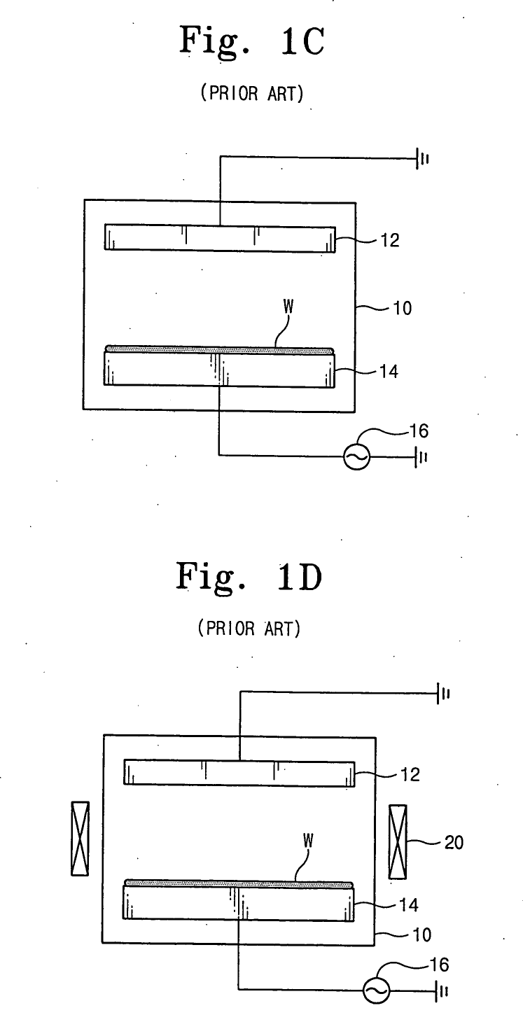

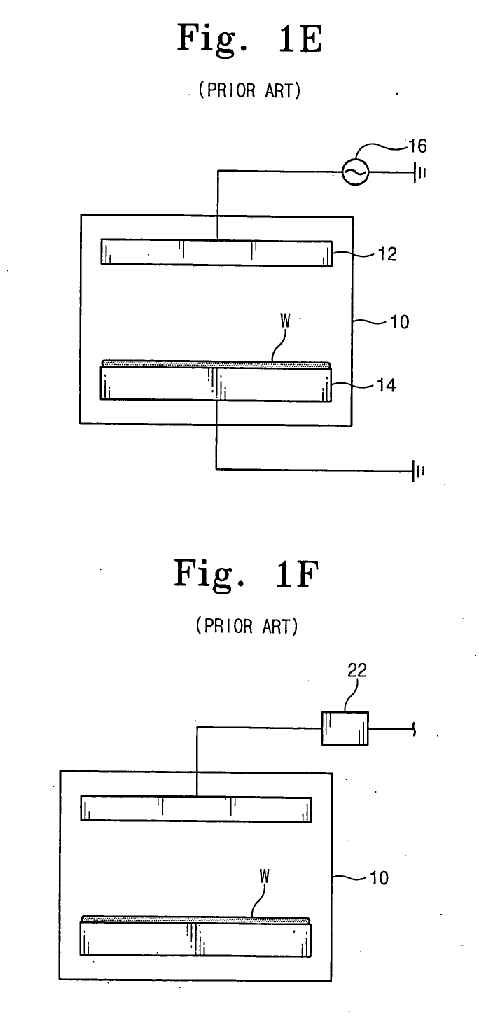

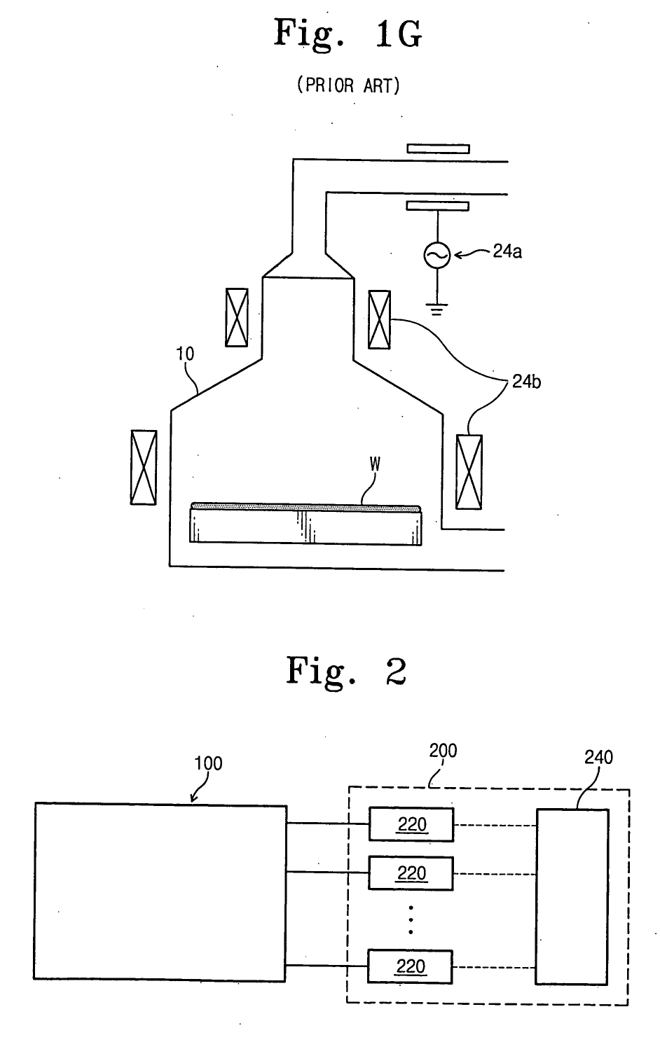

The plasma generators 220 are of different types. For example, each of the plasma generators 220 may be a Capacitively Coupled Plasma (CCP) generator, an Inductively Coupled Plasma (ICP) generator, a Reactive Ion Etching Plasma (RIE) generator, a Magnetically Enhanced Reactive Ion Etch (MERIE) plasma generator, an Electron Cyclotron Resonance (ECR) plasma generator, a direct plasma generator, or a remote plasma generator. The structures of such plasma generators are shown in FIG. 1a to 1g and are well known per se. Therefore, detailed descriptions of the plasma generators 220 will be omitted. However, the plasma generators 220 are not limited to these types.

The controller 240 selects one of more of the plasma generators 220 for use in a particular process to be carried out by the plasma treatment apparatus and sets the operating parameter(s) of the plasma generator/generators. When two or more of the plasma generators are selected, the controller 240 of the plasma treatment apparatus not only sets the operating parameters of the plasma generators 220 but also switches the use of (sequences) the plasma generators 220 during the (etch) process. The plasma generators 220 of the plasma treatment apparatus of the present invention thus serve as controls for the process in addition to the general process parameters such as pressure and temperature, amount and type of process gas, duration and magnitude of the applied high frequency electromagnetic field, etc. That is, the sequence of operation of the plasma generators 220 and their operating parameters can be fixed or variable during the process, like the general operating parameters, in order to etch the wafer more effectively. Therefore, the efficiency of the etch process can be increased in comparison to the conventional art because the plasma generators 220 expand the range of process parameters that can be controlled and adjusted.

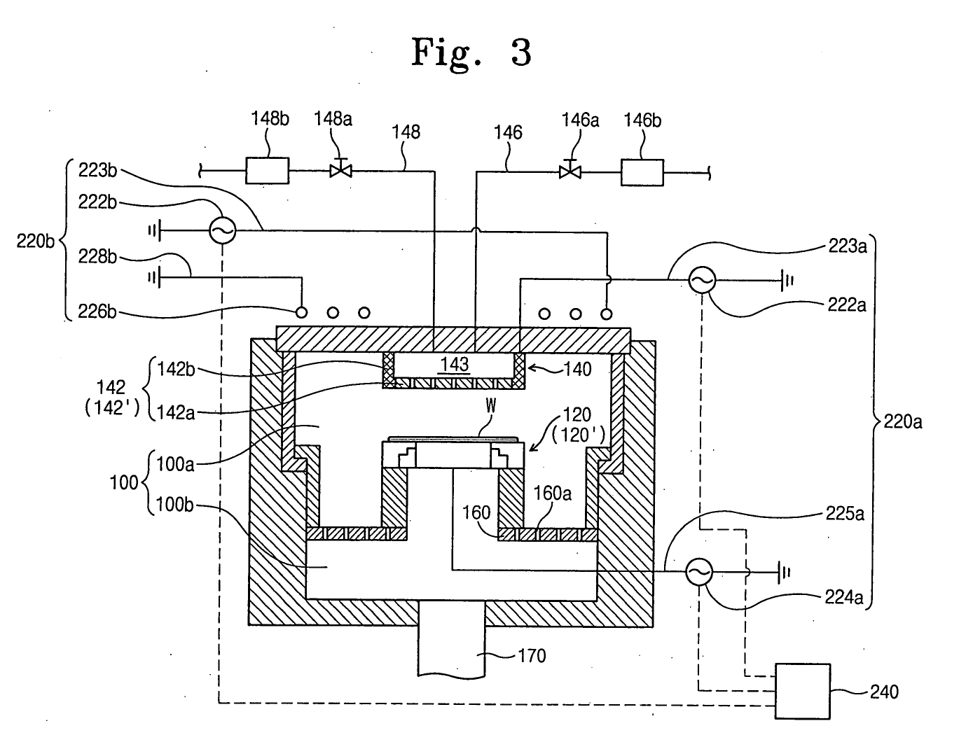

FIG. 3 illustrates an embodiment of the plasma treatment apparatus of present invention. Referring to FIG. 3, the plasma treatment apparatus includes a process chamber 100 and a plasma generation system 200. The process chamber 100 includes a treatment chamber 100a and a discharge chamber 100b. The treatment chamber 100a provides a space in which the (etch) process is carried out, and the discharge chamber 100b provides a space from which by-products of the reaction that takes place in the reaction chamber 100a, etc., are discharged from the process chamber 100. The treatment chamber 100a is disposed above the discharge chamber 100b. A substrate support 120 is disposed in the middle of the treatment chamber 100a. The substrate support 120 is configured to support the wafer W. A discharge plate 160 is situated below the substrate support 120 and divides the space within the process chamber 100 to partition the treatment chamber 100a and the discharge chamber 100b from one another.

To this end, the discharge plate 160 is generally ring-shaped. An inner peripheral portion of the discharge plate 160 contacts the substrate support 120 and an outer peripheral portion of the discharge plate 160 contacts an inner wall of the process chamber 100. A plurality of discharge holes 160a extend vertically through the discharge plate 160. The by-products of the reaction that takes place in the treatment chamber 100a are discharged through the discharge holes 160a to the discharge chamber 100b. A pump (not shown) is installed in the discharge chamber 100b to regulate the pressure within the process chamber 100. A discharge line 170 is connected to the discharge chamber 100b. By-products of the reaction are evacuated outward through the discharge line 170.

The apparatus also comprises a gas supply system 140 including a showerhead 142 and a plurality of gas supply lines 146, 148. The showerhead 142 is disposed in the treatment chamber 100a as facing the substrate support 120. The showerhead 142 includes an injection plate 142a and a sidewall 120b. The injection plate 142a is spaced from an upper wall of the treatment chamber 100a. The sidewall 142b extends from the outer circumferential edge of the injection plate 142a into contact with the upper wall of the treatment chamber 100a. The injection plate 142a has a diameter similar to that of the wafer W. The injection plate 142a has a plurality of gas injection holes extending vertically therethrough.

The gas supply lines 146, 148 are for supplying process gas to the showerhead 142 from external gas storage vessels (not shown). More specifically, the process gas is introduced from the gas supply lines 146, 148 into a space 143 defined by and between the upper wall of the process chamber 100 and the shower head 142. Although two gas supply lines 146, 148 are shown, more than two gas supply lines may be provided. In any case, different types of gas are supplied through the gas supply lines. Also, a respective gate valve 146a, 148a can be disposed in each gas supply line 146, 148 for selectively closing and opening the line. Likewise, a respective flow controller 146b, 148b can be disposed in each gas supply line 146, 148 for controlling the rate at which the process gas flows through the gas supply line 146, 148.

As mentioned above in connection with the description of FIG. 2, the plasma treatment apparatus also comprises a plasma generation system including a plurality of plasma generators, and a controller for controlling the plasma generators. In the embodiment of FIG. 3, the plasma generators 220 are a Capacitively Coupled Plasma (CCP) generator 220a and an Inductively Coupled Plasma (ICP) plasma generator 220b. The CCP source 220a includes a first high frequency line 223a, a high frequency power source 222a connected to the first high frequency line 223a, a second high frequency line 225a, and a high frequency power source 224a connected to the second high frequency line 225a. The first high frequency line 223a is connected to an upper electrode 142′, and the second high frequency line 225a is connected to a lower electrode 120′. The lower electrode 120′ is disposed within the substrate support 120, and the showerhead 142 serves as the upper electrode 142′. To this end, the showerhead 142 is of a metal material. The ICP generator 220b includes a coil 226b disposed outside of the process chamber 100, a high frequency line 223b, a high frequency power source 222b connected to the high frequency line 223b, and a ground line 228b. One end of the coil 226b is connected to the high frequency power source 222b through the high frequency line 223b. Thus, the coil 226b generates a high frequency electromagnetic field. The other end of the coil 226b is connected to the ground line 228b.

The controller 240 can control the plasma generators 220a, 220b such that only a selected one of the plasma generators 220 is operating during the (etch) process. More specifically, the controller 240 controls the plasma generators 220a, 220b such that one of the plasma generators 220a and 220b is used for an initial period of time, and then the other of the plasma generators 220a and 220b is used for the duration of the process. Alternatively, the controller 240 controls the plasma generators 220a, 220b such that only one of the plasma generators 220a and 220b is selectively used throughout the entire duration of the process.

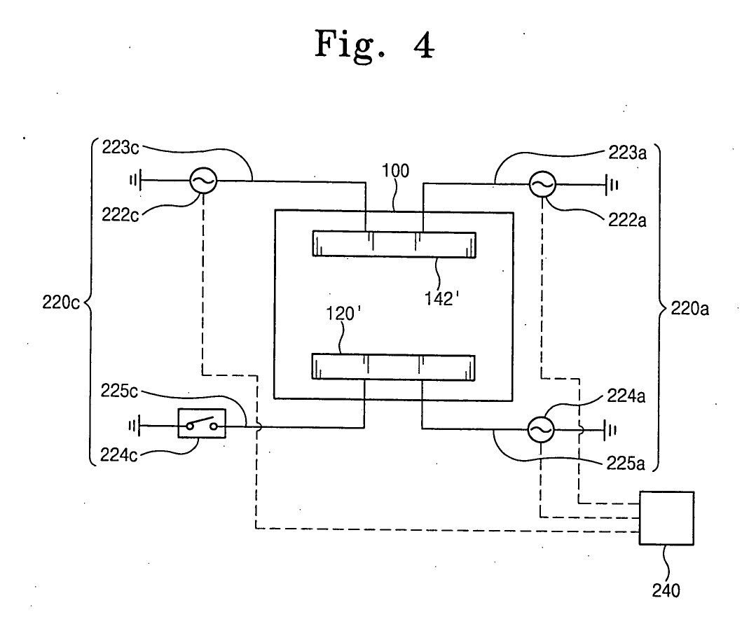

FIG. 4 to FIG. 6 illustrate other embodiments, respectively, of plasma treatment apparatuses according to the present invention. In these figures, the process chamber 100 and the upper electrode 142” and the lower electrode 120′ are roughly illustrated for the sake of clarity. The plasma treatment apparatuses will be briefly described in detail hereinafter, focus being given upon the plasma generation systems.

In the embodiment of FIG. 4, the plasma generation system of the plasma treatment apparatus includes a CCP generator 220a, a direct plasma generator 220c, and a controller 240. The CCP generator 220a includes a first high frequency line 223a, a high frequency power source 222a connected to the first high frequency line 223a, a second high frequency line 225a, and a high frequency power source 224a connected to the second high frequency line 225a. The first high frequency line 223a is also connected to an upper electrode 142′, and the second high frequency line 225a is connected to a lower electrode 120′. The direct plasma generator 220c includes a high frequency line 223c, a high frequency power source 222c connected to the high frequency line 223c, a ground line 225c, and an on/off switch 224c disposed in-line with the ground line 225c. The high frequency line 223c is also connected to the upper electrode 142′, and the ground line 225c is connected to the lower electrode 120′.

The controller 240 selectively operates the plasma generators 220a, 220c during the (etch) process. For instance, the controller 240 turns the switch 224c in the ground line 225c off when plasma is generated from the process gas by the CCP generator 220a. On the other hand, the controller 240 turns the switch 224c on when the plasma is generated from the process gas by the direct plasma generator 220c.

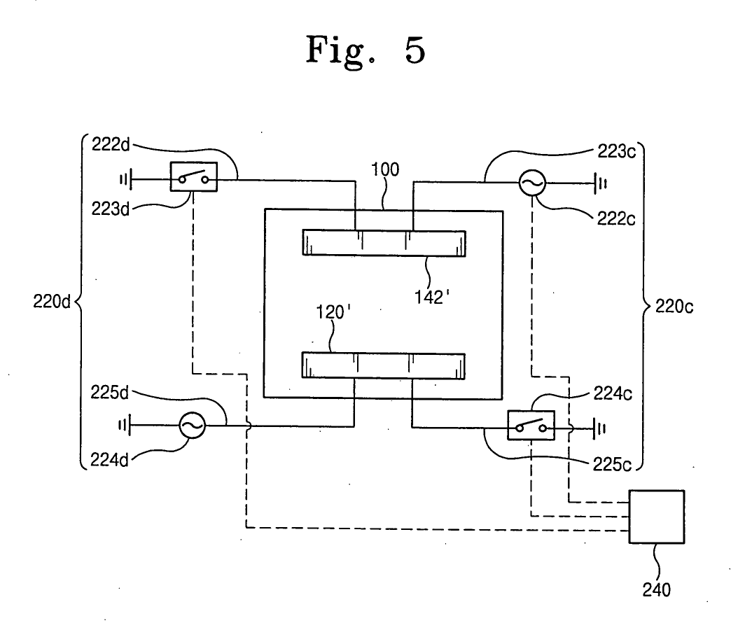

FIG. 5 shows the basic structure of an embodiment of a plasma treatment apparatus having a plasma generation system that includes a direct plasma generator220c, a Reactive Ion Etching (RIE) plasma generator 220d, and a controller 240. The direct plasma generator 220c includes a high frequency line 223c, a high frequency power source 222c connected to the high frequency line 223c, a ground line 225c, and an on/off switch 224c disposed in-line with the ground-line line 225c. The high frequency line 223c is also connected to an upper electrode 142′, and the ground line 225c is connected to a lower electrode 120′. The RIE plasma generator 220d includes a high frequency line 225d, a high frequency generator 224d connected to the high frequency line 225d, a ground line 222d, and an on/off switch 223d disposed in-line with the ground line 222d. The high frequency line 225d is also connected to the lower electrode 120′, and the ground line 222d is connected to the upper electrode 142′. The controller 240 selectively operates the plasma sources 220c, 220d such that only one of the plasma generators is used at a time during the (etch) process.

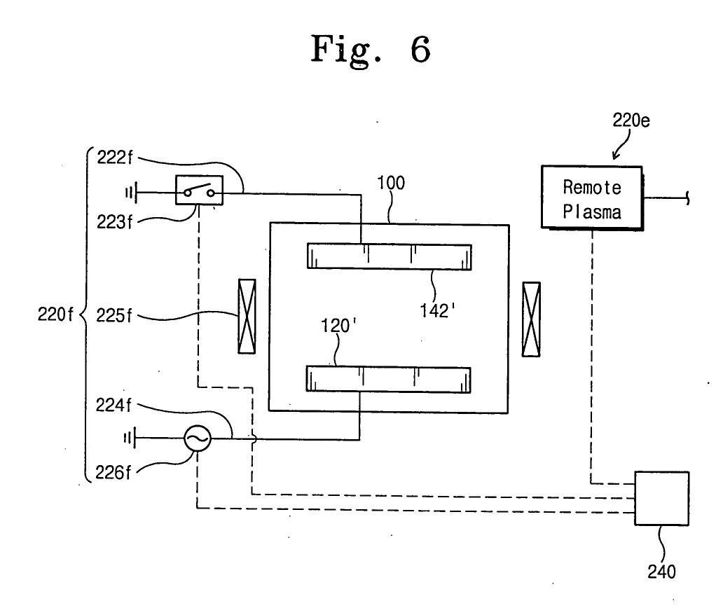

FIG. 6 shows the basic structure of an embodiment of a plasma treatment apparatus having a plasma generation system that includes a remote plasma generator 220e and a Magnetically Enhanced Reactive Ion Etch (MERIE) plasma generator 220f. The remote plasma generator 220e is situated outside the process chamber 100, and generates the plasma from the process gas before the process gas enters the process chamber 100. The MERIE plasma generator 220f includes a high frequency line 224f, a high frequency power source 225f connected to the high frequency line 224f, a ground line 222f, and an on/off switch 223f disposed in-line with the ground line 222f. The high frequency line 224f is also connected to a lower electrode 120′, and the ground line 222f is connected to an upper electrode 142′. The MERIE plasma generator 220f also includes magnets 226f disposed outside the process chamber 100.

In the embodiments of FIGS. 3 to 6 described above, the plasma treatment apparatuses each included only two plasma generators 220. However, a plasma treatment apparatus according to the present invention may have three or more plasma generators. Moreover, a plasma treatment apparatus according to the present invention may have a combination of two plasma generators different than each of the combinations of plasma generators described above in connection with the embodiments of FIGS. 3 to 6.

In any case, a plasma treatment apparatus of the present invention can be used to carry out a variety of processes because the apparatus includes not one plasma generator but a plurality of plasma generators. For instance, the plasma treatment apparatus of FIG. 3 can be used not only to carry out a process that requires plasma generated using the CCP generator 220a, but also to carry out a process that requires plasma generated by the ICP generator 220b. Also, according to the present invention, the use of the plasma generators 220 can be changed during the process. Therefore, the operating parameters of the plasma sources 220 may also constitute the process parameters in addition to the more general and conventional process parameters such as the type of process gas, and the pressure and temperature at which the process is carried out. By expanding the range and number of adjustable process factors in this way, the present invention allows for a plasma treatment process to be carried out with a correspondingly higher degree of efficiency.

An example of a method of carrying out an etch process using a plasma treatment apparatus according to the present invention will now be explained. The etch process forms a pattern of holes or lines in a film on a wafer W. A plasma generator capable of providing a higher etch rate is used to carry out the etch process during less critical periods of the process, whereas a plasma generator that allows the film to be etched at a lower and hence, more controllable, rate is used during a critical period of the process. As a specific example, the plasma generator capable of providing a higher etch rate is used during the initial period of a process of forming a deep contact hole in a film on a wafer W. Therefore, the initial part of the process can be carried out in a relatively short amount of time. Then the plasma generator that allows the film to be etched at a lower etch rate is used to finish the etch process. Accordingly, the forming of the deep contact hole is finely tuned. This applies not only to a film of a single layer but also for multi-layered films to be etched.

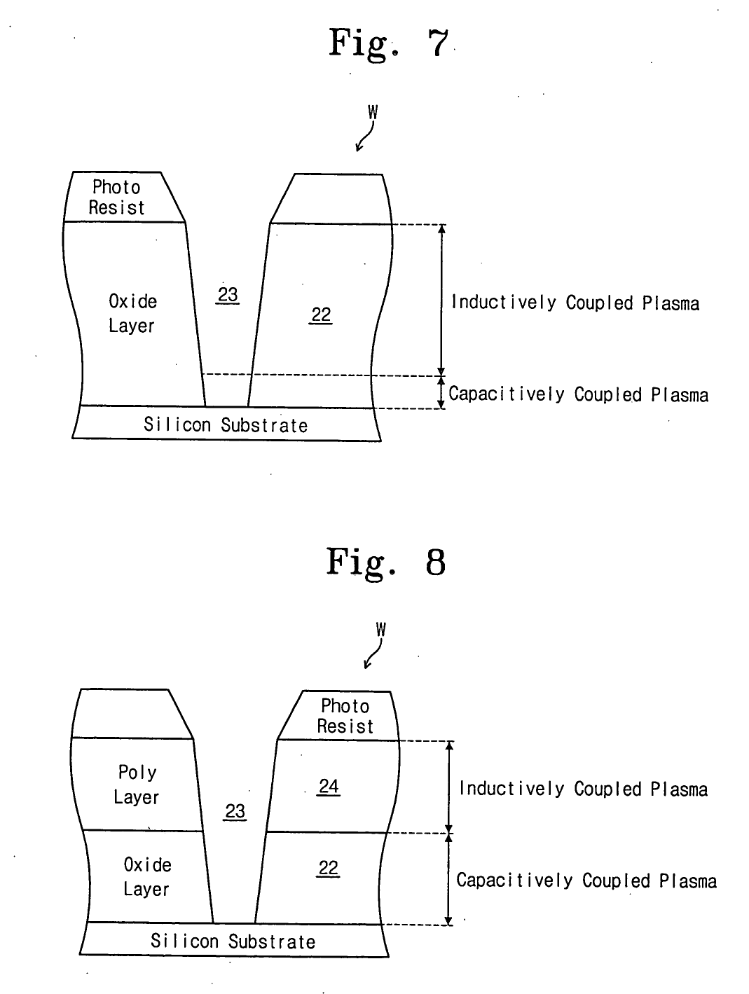

FIG. 7 illustrates an example of the sequence in which the plasma generators 220 of the plasma treatment apparatus of FIG. 3 are used while a deep contact hole 23 is formed in an oxide layer 22 on a wafer W. As shown in FIG. 7, the ICP generator 220b is used initially, and the CCP generator 220a is used after the ICP generator 220b. In addition to the operating times of the plasma sources, other factors affecting the etch process, such as process pressure, temperature, type of process gas, and duration and magnitude of the applied high frequency electromagnetic field applied, etc. can be changed during the process.

FIG. 8 illustrates an example of the sequence in which a multi-layered film is etched. In this case, the plasma generators 220 may be switched at the time a sub-layer of the film is exposed. For instance, when a contact hole 23 is to be formed in a oxide layer 22 and a poly layer 24 on a wafer W using the plasma treatment apparatus of FIG. 3, the ICP generator 220b is used for etching the poly layer 24 and the CCP generator 220a is used for etching the oxide layer 22. Other process parameters affecting the etch process, such as process pressure, temperature, type of process gas, etc. can also be changed during the etch process. For example, argon (Ar), helium (He), and CF4 can be used as process gas to form the plasma for etching the poly layer 24, whereas Cl2, SF6, oxygen (O2), and helium (He) can be used as process gas to form the plasma for etching the oxide layer 22.

The processes described above are only some examples of the applications of the present invention. The type of plasma generators 220, and the sequence of use of the plasma generators 220 and the other process parameters, may vary from those described above in accordance with a particular plasma treatment process to be performed.

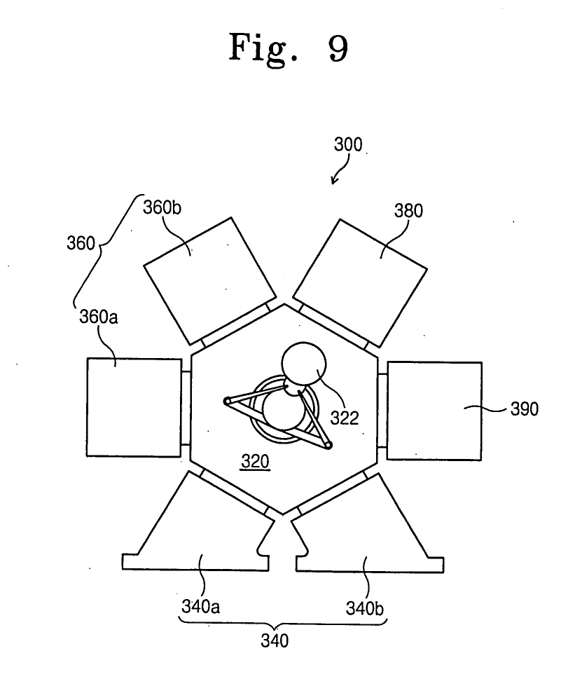

FIG. 9 illustrates a facility for manufacturing semiconductor devices (or the like) 300 that includes a plurality of a plasma treatment apparatuses 360 according to the present invention. Referring to FIG. 9, the facility for manufacturing semiconductor devices 300 includes a transfer chamber 320, at least one load lock chamber 340, and a plurality of plasma treatment apparatuses 360. The transfer chamber 320 is disposed at the center of the facility, and a robot 322 is located inside the transfer chamber 320. The robot 322 transfers wafers between the various chambers of the facility. The load lock chamber(s) 340 and the plasma treatment apparatuses 360 are clustered around the transfer chamber 320. The facility for manufacturing semiconductor devices 300 can include other apparatuses for processing the wafers subsequent to the plasma treatment. When the plasma treatment apparatuses 360 of the facility are, for example, apparatuses for etching wafers, the facility 300 may also include an ashing apparatus 380 for carrying out an ashing process and a wet stripping apparatus 390 for carrying a wet strip process in which photoresist layers are removed from the wafers after the wafers have been etched. In addition, a developing apparatus (not shown) may be attached to the transfer chamber 320. Such a developing apparatus is for carrying out a developing process in which select portions of an exposed photoresist layer are removed from a wafer before the wafer is etched to form a mask used in the etching process.

Each of the plasma treatment apparatuses 360 includes a single plasma generator, but at least two of the plasma generators of the plasma treatment apparatuses 360 are of different types. For example, in the embodiment of the facility for manufacturing semiconductor devices 300, a first load-lock chamber 340a, a first plasma treatment apparatus 360a having a first plasma generator, a second plasma treatment apparatus 360b having a second plasma generator of a type different from that of the first plasma generator, an ashing apparatus 380, a wet strip apparatus 390, and a second load-lock chamber 340b are disposed around the transfer chamber 320 in a clockwise direction. The facility for manufacturing semiconductor devices 300 carries out etch processes to form a hole or line pattern in a layer on a wafer. The plasma generator of the first plasma treatment apparatus 360a is an ICP generator, and the plasma source of the second plasma treatment apparatus 360b is a CCP generator. In operation, a wafer is introduced into the facility through the load lock chamber 340a. The wafer is then transferred by the transfer robot 322 sequentially to the first plasma treatment apparatus 360a, to the second plasma treatment apparatus 360b, to the ashing apparatus 380, and to the wet strip apparatus 390. Subsequently, i.e., when the processing of the wafer is complete, the wafer is transferred to the outside of the apparatus through the load lock chamber 340b.

When a contact hole is to be formed in a single layer such as an oxide layer, the wafer is initially transferred to the first plasma treatment apparatus 360a. The first plasma treatment apparatus 360a etches the oxide layer at a relatively high etch rate using the ICP generator. After certain period of time has elapsed, the wafer is transferred to the second plasma treatment apparatus 360b. The second plasma treatment apparatus 360b continues etching the oxide with the CCP generator, i.e., at an etch rate that is less than that provided by the ICP generator of the first plasma treatment apparatus 360a. The same method can be used to form a contact hole in a multi-layered film on a wafer, e.g., in a film that includes a poly layer and an oxide layer. In this case, the poly layer can be etched in the first plasma treatment apparatus 360a, and then the oxide layer can be etched in the second plasma treatment apparatus 360b.

The embodiment of FIG. 9 has been specifically described above as having two plasma treatment apparatuses. However, the present invention is not so limited. A facility for manufacturing semiconductor devices or the like according to the present invention may employ three or more plasma treatment apparatuses having plasma generators, respectively, of types that are different form each other.

That is, although the present invention has been described above in connection with the preferred embodiments thereof, the present invention is not so limited. Rather, various substitutions, modifications and changes may be made to the preferred embodiments without departing from the true spirit and scope of the invention as defined by the appended claims.

What is claimed is:

1. A plasma treatment apparatus comprising:
a process chamber;
a substrate support disposed in the process chamber and dedicated to support a substrate while the substrate is processed within the chamber; a gas supply system connected to the process chamber; and
a plasma generation system including a plurality of plasma generators each of which is independently operable to produce plasma using process gas supplied by the gas supply system, the plasma generators being of different types.

2. The apparatus of claim 1, wherein the plasma generation system further comprises a controller operatively connected to the plasma generators and configured to selectively operate the plasma sources.

3. The apparatus of claim 1, wherein the plasma generators are selected from the group consisting of a Capacitively Coupled Plasma (CCP) generator, an Inductively Coupled Plasma (ICP) generator, a Reactive Ion Etching (RIE) plasma generator, a Magnetically Enhanced Reactive Ion Etch (MERIE) plasma generator, an Electron Cyclotron Resonance (ECR) plasma generator, a direct plasma generator, and a remote plasma generator.

4. The apparatus of claim 1, wherein the plasma generators are a Capacitively Coupled Plasma (CCP) generator and an Inductively Coupled Plasma (ICP) generator.

5. The apparatus of claim 1, wherein the plasma generator each include at least one respective power source, and the plasma generation system further comprises a controller operatively connected to the power sources and configured to selectively switch the power sources of each of the plasma generators on and off independently of each other.

6. A facility for processing substrates using plasma, the facility comprising:
a transfer chamber;
a transfer robot disposed in the transfer chamber; and
a plurality of plasma treatment apparatuses connected to the transfer chamber, each of the plasma treatment apparatus comprising a plasma generator, the plasma generator of at least one of the plasma treatment apparatuses being of a type that is different from that of another of the plasma treatment apparatuses.

7. The facility of claim 6, further comprising:
an ashing apparatus connected to the transfer chamber; and
a wet strip apparatus connected to the transfer chamber.

8. A method of treating a substrate using plasma, the method comprising:
forming a plasma using a first plasma generator, and initially treating a substrate with the plasma to form part of a feature on the substrate; and
forming another plasma with a second plasma generator of a type that is different from that of the first plasma generator, and subsequently treating the substrate with the plasma formed using the second plasma generator to form a continuation of the feature on the substrate.

9. The method of claim 8, wherein the forming of the plasma using the first plasma generator and the forming of the plasma using the second plasma generator each comprise a respective one of forming a Capacitively Coupled Plasma (CCP), an Inductively Coupled Plasma (ICP), forming a Reactive Ion Etching Plasma (RIE), forming a Magnetically Enhanced Reactive Ion Etch Plasma (MERIE), forming an Electron Cyclotron Resonance (ECR), forming a plasma by only applying a high frequency power to an electrode in a process chamber in which the substrate is treated with the plasma so formed, and forming a plasma outside a process chamber in which the substrate is treated with the plasma so formed.

10. The method of claim 9, wherein the treating of the substrate with the plasma formed using the first plasma generator and the treating of the substrate with the plasma formed using the plasma generator each comprises etching material on the substrate.

11. The method of claim 10, wherein the treating of the substrate with the plasma formed using the second plasma generator comprises etching material on the substrate at rate lower than that in which material on the substrate is etched with the plasma formed using the first plasma generator.

12. The method of claim 11, wherein the forming of the plasmas comprise forming a Capacitively Coupled Plasma (CCP) and an Inductively Coupled Plasma (ICP).

13. The method of claim 12, wherein the forming of the plasma using the second plasma generator comprises forming the Capacitively Coupled Plasma (CCP) and the forming of the plasma using the first plasma generator comprises forming the Inductively Coupled Plasma (ICP).

14. The method of claim 10, wherein the material that is etched comprises a plurality of layers of different material, and the treating of the substrate with the plasma formed using the first plasma generator comprises etching one of the layers, and the treating of the substrate with the plasma formed using the second plasma generator comprises etching another of the layers.

15. A method of treating a substrate with plasma, the method comprising:
etching a single layer of material on a substrate through only part of its thickness by forming a plasma using a first plasma generator, and initially treating a substrate with the plasma formed using the first plasma generator; and
subsequently continuing the etching of the single layer of material on the substrate by forming a plasma using a second plasma generator of a type that is different from that of the first plasma generator, and treating the substrate with the plasma formed using the second plasma generator.

16. The method for claim 15, wherein the substrate is treated in the same process chamber with the plasmas formed using the first and second plasma generators, and the method comprises switching the use of the plasma generators during the etching of the single layer of material.

17. The method of claim 16, further comprising transferring the substrate among a plurality of process chambers, and wherein the etching of the single layer of material through only part of its thickness using the first plasma generator is carried out in one of the process chambers, and the subsequent etching of the single layer of material using the second plasma generator is carried out in another of the process chambers.

18. The method of claim 17, wherein the treating of the substrate with the second plasma comprises etching the single layer of material on the substrate at rate lower than that in which single layer of material on the substrate is etched using the first plasma.

19. The method of claim 15, wherein the forming of the plasma using the second plasma generator comprises forming a Capacitively Coupled Plasma (CCP) and the forming of the plasma using the first plasma generator comprises forming an Inductively Coupled Plasma (ICP).

20. The method of claim 16, wherein the forming of the plasma using the first plasma generator and the forming of the plasma using the second plasma generator each comprise a respective one of forming a Capacitively Coupled Plasma (CCP), forming an Inductively Coupled Plasma (ICP), forming a Reactive Ion Etching (RIE) plasma, forming a Magnetically Enhanced Reactive Ion Etch (MERIE) plasma, forming an Electron Cyclotron Resonance (ECR), forming a plasma by only applying a high frequency power to an electrode in a process chamber in which the substrate is treated with the plasma so formed, and forming a plasma outside a process chamber in which the substrate is treated with the plasma so formed.
